(19) United States
(12) Patent Application Publication
(10) Pub. No.: US 2024/0398013 A1
(43) Pub. Date: Dec. 5, 2024

(54) AEROSOL-GENERATING DEVICE

(71) Applicant: KT&G CORPORATION, Daejeon (KR)

(72) Inventors: Youngbum KWON, Yongin-si Gyeonggi-do (KR); Younji SHIN, Seoul (KR); Hanyong LEE, Seoul (KR); Seoksu JANG, Daejeon (KR)

(73) Assignee: KT&G CORPORATION, Daejeon (KR)

(21) Appl. No.: 18/667,302

(22) Filed: May 17, 2024

(30) Foreign Application Priority Data
May 30, 2023 (KR) 10-2023-0069565
Aug. 21, 2023 (KR) 10-2023-0109079

(51) Int. Cl. A24F 40/46; A24F 40/10; A24F 40/20; A24F 40/30; H05B 3/14

(52) U.S. Cl. CPC A24F 40/46; A24F 40/10; A24F 40/20; A24F 40/30; H05B 3/145; H05B 2203/006; H05B 2203/007; H05B 2203/013; H05B 2203/016; H05B 2203/037; H05B 2214/04

(57) ABSTRACT

An aerosol-generating device is disclosed. The aerosol-generating device includes a body including an insertion space to allow a stick to be inserted into the insertion space and a heater disposed in the body and including a heat generating portion configured to heat the insertion space. The heat generating portion includes a heat generating layer surrounding the insertion space and a wiring layer stacked on the heat generating layer and configured to supply a current. The heat generating portion has a thickness varying in the depth direction of the insertion space.

### CROSS-REFERENCE TO RELATED APPLICATIONS

Pursuant to 35 U.S.C. § 119(a), this application claims the benefit of earlier filing date and right of priority to Korean Patent Application Nos. 10-2023-0069565, filed on May 30, 2023 and 10-2023-0109079, filed on Aug. 21, 2023, the contents of which are all hereby incorporated by reference herein in their entirety.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

An aerosol-generating device generates an aerosol by heating an aerosol-generating substance using a heater. A conventional metal heater made of copper, constantan, or the like has a problem in that much time and power are consumed to generate heat to reach a temperature for generation of an aerosol.

A carbonaceous material such as carbon nanotubes or graphene has high thermal conductivity compared to conventional general metals. If a heater made of a carbonaceous material is applied to an aerosol-generating device, it may take only a few seconds or less to generate heat to reach a temperature for generation of an aerosol.

A stick configured to be heated by a heater may include a suction portion, with which a user brings his/her body into contact as needed, and a heating portion, which contains various flavoring substances and is heated by the heater. The heating portion may be divided into a plurality of regions depending on the composition and phase of components contained therein. The plurality of regions has different adequate heating temperature ranges depending on the nature of components contained therein. However, the conventional heater is not capable of heating the respective regions to adequate heating temperatures thereof.

### DISCLOSURE

### Technical Problem

It is an object of the present disclosure to solve the above and other problems.

It is another object of the present disclosure to provide an aerosol-generating device equipped with a heater made of a carbonaceous material.

It is still another object of the present disclosure to provide an aerosol-generating device equipped with a heater configured to heat respective regions of a stick to adequate temperatures thereof.

It is still another object of the present disclosure to provide an aerosol-generating device equipped with a heater exhibiting improved heat generation performance.

It is still another object of the present disclosure to provide an aerosol-generating device equipped with a heater exhibiting improved power efficiency.

It is still another object of the present disclosure to provide an aerosol-generating device capable of diffusing heat generated from a heater.

It is still another object of the present disclosure to provide an aerosol-generating device capable of simplifying the structure thereof.

It is still another object of the present disclosure to provide an aerosol-generating device capable of simplifying control of a heater.

### Technical Solution

In accordance with an aspect of the present disclosure, the above and other objects can be accomplished by the provision of an aerosol-generating device including a body including an insertion space to allow a stick to be inserted into the insertion space and a heater disposed in the body and including a heat generating portion configured to heat the insertion space, wherein the heat generating portion includes a heat generating layer surrounding the insertion space and a wiring layer stacked on the heat generating layer and configured to supply a current, and the heat generating portion has a thickness varying in the depth direction of the insertion space.

### Advantageous Effects

According to at least one of embodiments of the present disclosure, since a heater made of a carbonaceous material is employed, it is possible to reduce a time required to heat the heater and to increase user satisfaction.

According to at least one of embodiments of the present disclosure, since heat generating portions corresponding to respective portions of a stick are formed to have different thicknesses, it is possible to heat various substances contained in the stick to adequate temperatures and to improve heat generation performance and power efficiency.

According to at least one of embodiments of the present disclosure, it is possible to simplify the structure and control of the heater by varying the thickness of a single wiring layer or stacking a single wiring layer onto heat generating layers having different thicknesses.

According to at least one of embodiments of the present disclosure, since a second heat generating portion is formed such that the thickness or wiring density thereof is gradually reduced in a direction approaching a first heat generating portion, it is possible to minimize the influence of the second heat generating portion on the first heat generating portion.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

The above and other objects, features and other advantages of the present disclosure will be more clearly understood from the following detailed description taken in conjunction with the accompanying drawings, in which:

FIGS. 1 and 2 are views showing aerosol-generating devices according to embodiments of the present disclosure;

FIG. 3 is view showing a stick and a heater according to an embodiment of the present disclosure;

FIG. 4 is a cross-sectional view of a heat generating portion according to embodiments of the present disclosure;

FIG. 5 is a cross-sectional view of FIG. 3;

FIG. 6 is a cross-sectional view of the heat generating portion according to embodiments of the present disclosure;

FIG. 7 is a view showing a wiring layer according to an embodiment of the present disclosure;

FIG. 8 is a view showing a wiring layer according to another embodiment of the present disclosure;

FIG. 9 is a view showing a heat generating portion according to another embodiment of the present disclosure;

FIG. 10 is a view showing a heat generating portion according to another embodiment of the present disclosure;

FIG. 11 is a schematic view showing a wiring layer that varies in structure in the depth direction of an insertion space according to another embodiment of the present disclosure;

FIG. 12 is a schematic view showing a wiring layer that varies in structure in the depth direction of the insertion space according to another embodiment of the present disclosure; and

FIG. 13 is a block diagram of an aerosol-generating device according to an embodiment of the present disclosure.

### MODE FOR INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout the present specification, the directions of an aerosol-generating device and a cartridge may be defined based on the orthogonal coordinate system. In the orthogonal coordinate system, the x-axis direction may be defined as a leftward-rightward direction of the aerosol-generating device and the cartridge. Here, based on the origin, the +x-axis direction may be the rightward direction, and the −x-axis direction may be the leftward direction. The y-axis direction may be defined as a forward-backward direction of the aerosol-generating device and the cartridge. Here, based on the origin, the +y-axis direction may be the backward direction, and the −y-axis direction may be the forward direction. The z-axis direction may be defined as an upward-downward direction of the aerosol-generating device and the cartridge. Here, based on the origin, the +z-axis direction may be the upward direction, and the −z-axis direction may be the downward direction.

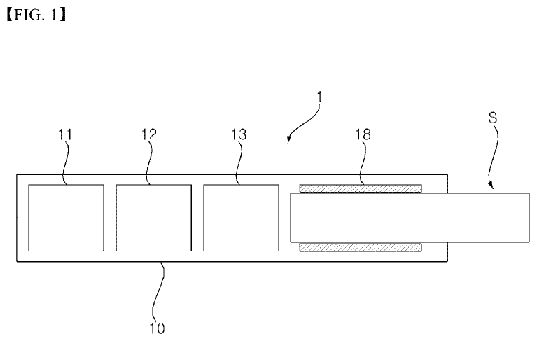

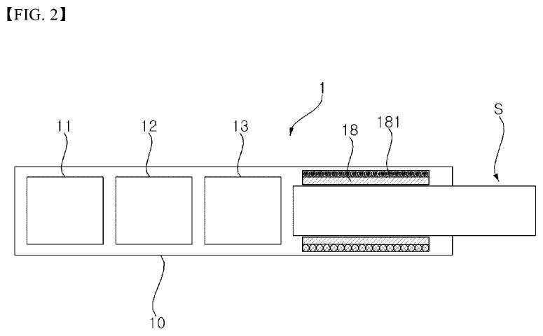

FIGS. 1 and 2 are views showing aerosol-generating devices 1 according to embodiments of the present disclosure.

Referring to FIG. 1, the aerosol-generating device may include at least one of a power supply 11, a controller 12, a sensor 13, or a heater 18. At least one of the power supply 11, the controller 12, the sensor 13, or the heater 18 may be disposed in a body 10 of the aerosol-generating device. The body 10 may define a space having an open top to allow a stick S, which is an aerosol-generating article, to be inserted thereinto. The space having an open top may be referred to as an insertion space. The insertion space may be formed so as to be depressed to a predetermined depth toward the interior of the body 10 so that the stick S is inserted at least partway thereinto. The depth of the insertion space may correspond to the length of the portion of the stick S that contains an aerosol-generating substance and/or medium. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat the stick S. The heater 18 may be disposed around the space into which the stick S is inserted and may be elongated upward. For example, the heater 18 may be formed in a shape of a tube including a cavity formed therein. The heater 18 may be disposed around the insertion space. The heater 18 may be disposed so as to surround at least a portion of the insertion space. The heater 18 may heat the insertion space or the stick S inserted into the insertion space. The heater 18 may include an electro-resistive heater and/or an induction heater.

For example, referring to FIG. 1, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11. The heater 18 may be formed in a hollow shape so as to surround at least a portion of the stick S inserted into the insertion space and thus to heat the outer side of the stick S or may be formed in a needle shape, a rod shape, or a tube shape so as to be inserted into the stick S inserted into the insertion space and thus to heat the interior of the stick S.

For example, referring to FIG. 2, the aerosol-generating device may include an induction coil 181 surrounding the heater 18. The induction coil 181 may cause the heater 18 to generate heat. The heater 18 as a susceptor may generate heat using a magnetic field generated by alternating current flowing through the induction coil 181. The magnetic field may pass through the heater 18 to generate an eddy current in the heater 18. The current may cause the heater 18 to generate heat.

Meanwhile, a susceptor may be included in the stick S, and the susceptor in the stick S may generate heat using a magnetic field generated by alternating current flowing through the induction coil 181.

The power supply 11 may supply power so that components of the aerosol-generating device operate. The power supply 11 may be referred to as a battery. The power supply 11 may supply power to at least one of the controller 12, the sensor 13, or the heater 18. If the aerosol-generating device 1 includes the induction coil 181, the power supply 11 may supply power to the induction coil 181.

The controller 12 may control overall operation of the aerosol-generating device. The controller may be mounted on a printed circuit board (PCB). The controller 12 may control operation of at least one of the power supply 11 or the sensor 13. The controller 12 may control operation of the induction coil 181. The controller 12 may control operation of a display, a motor, etc. mounted in the aerosol-generating device. The controller 12 may check the state of each of the components of the aerosol-generating device and may determine whether the aerosol-generating device is in an operable state.

The controller 12 may analyze a result of detection by the sensor 13 and may control subsequent processes. For example, the controller 12 may control, based on a result of detection by the sensor 13, power supplied to the heater 18 so that operation of the heater 18 commences or ends. For example, the controller 12 may control, based on a result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space.

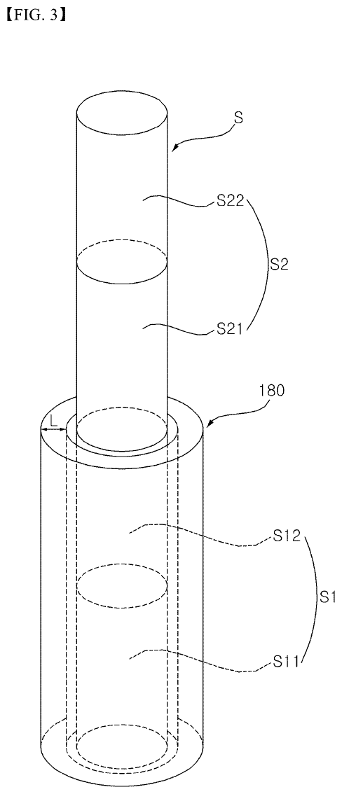

FIG. 3 is view showing the stick and the heater according to the embodiment of the present disclosure.

Referring to FIG. 3, the stick S may include an inserted portion S1 disposed in the insertion space and an exposed portion S2 extending from the inserted portion S1 and exposed to the outside.

The inserted portion S1 may be inserted into the insertion space. The inserted portion S1 may be directly heated by the heater 18. The heater 18 may surround the inserted portion S1. The inserted portion S1 may be a portion that is directly heated by the heater 18. The inserted portion S1 may contain a medium. The inserted portion S1 may contain a multicomponent flavoring substance. For example, the inserted portion S1 may contain a nicotine component, an herbal component, and/or a coffee component.

The inserted portion S1 may include a first substance portion S11 and a second substance portion S12. The first substance portion S11 may contain various stimulants. The first substance portion S11 may be inserted into the innermost portion of the insertion space. The first substance portion S11 may be an end portion of the stick S. The first substance portion S11 may contain a liquid substance. For example, the liquid substance may be a liquid cartridge. The liquid substance contained in the first substance portion S11 may be heated to form an aerosol. The liquid substance may be contained in the stick S. The liquid substance may include nicotine, various flavorings, and a liquid medium containing the same.

The second substance portion S12 may extend from the first substance portion S11. The second substance portion S12 may be a central portion of the stick S. The second substance portion S12 may be located between the exposed portion S2, which will be described later, and the first substance portion S11. For example, the second substance portion S12 may be located between a cooling portion S3, which will be described later, and the first substance portion S11. The second substance portion S12 may be inserted into a portion of the insertion space that is adjacent to the outside. The second substance portion S12 may contain a solid medium. The second substance portion S12 may contain a component different from that contained in the first substance portion S11. The component heated in the first substance portion S11 may pass through the second substance portion S12.

The exposed portion S2 may extend from the inserted portion S1. The inserted portion S1 may form a part of the stick S, and the exposed portion S2 may form the remaining part of the stick S. The exposed portion S2 may be located outside the insertion space. The exposed portion S2 may not be directly heated by the heater 18. The aerosol formed in the inserted portion S1 by being heated by the heater 18 may move to the exposed portion S2. The aerosol may be filtered while passing through the exposed portion S2. The aerosol may be cooled while passing through the exposed portion S2.

The exposed portion S2 may include a cooling portion S3 configured to cool the aerosol. The aerosol may be reduced in temperature while passing through the cooling portion S3. The cooling portion S3 may form the central part of the stick S. The cooling portion S3 may be located between a filter portion S22, which will be described later, and the second substance portion S12.

The exposed portion S2 may include a filter portion S22 configured to filter the material formed in the inserted portion S1. The filter portion S22 may be brought into contact with the user's body. For example, the user may perform inhalation while holding the filter portion S22 in the mouth. The filter portion S22 may form the other end portion of the stick S. For example, the first substance portion S11 may form one end portion of the stick S, and the filter portion S22 may form the other end portion of the stick S.

The heater 18 may include a heat generating portion 180 configured to generate heat. The insertion space may be defined in the heat generating portion 180. The heat generating portion 180 may surround the insertion space. For example, the heat generating portion 180 may surround the cylindrical insertion space. The heat generating portion 180 may surround the inserted portion S1 of the stick S. The heat generating portion 180 may directly heat the inserted portion S1 of the stick S. The heat generating portion 180 may heat the first substance portion S11 and the second substance portion S12. The heat generating portion 180 may extend by a length corresponding to the length of the inserted portion S1 of the stick S.

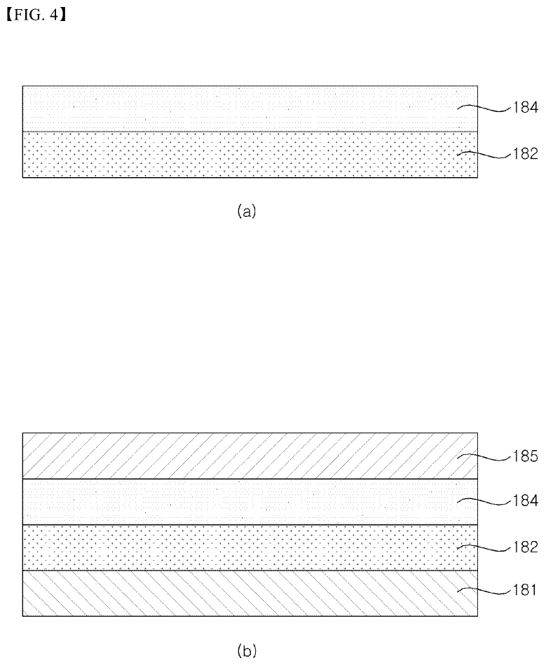

FIG. 4 is a cross-sectional view of the heat generating portion according to embodiments of the present disclosure.

Referring to FIG. 4, the heat generating portion 180 may include a heat generating layer 182 configured to generate heat when a current flows therethrough and a wiring layer 184 stacked on the heat generating layer 182.

The heat generating layer 182 may be formed to allow a current to flow therethrough. The heat generating layer 182 may generate heat when a current flows therethrough. The heat generating layer 182 may be formed of a carbonaceous material. For example, the heat generating layer 182 may be formed of graphene or carbon nanotubes (CNT). The heat generating layer 182 may have thermal conductivity. The heat generating layer 182 may have electrical conductivity. The heat generating layer 182 may be manufactured using at least one of chemical vapor deposition, arc discharge, laser deposition, vapor growth, or flame synthesis. The heat generating layer 182 may heat the insertion space. For example, the heat generating layer 182 may heat the stick S disposed in the insertion space.

The heat generating portion 180 may include a wiring layer 184 stacked on the heat generating layer 182. The wiring layer 184 may have electrical conductivity. The wiring layer 184 may include an electrically conductive pattern. The wiring layer 184 may be formed on the heat generating layer 182. The wiring layer 184 may be spaced apart from the insertion space. The heat generating layer 182 may be located between the wiring layer 184 and the insertion space. That is, the heat generating layer 182 may surround the insertion space, and the wiring layer 184 may surround the heat generating layer 182. The wiring layer 184 may surround the insertion space. The wiring layer 184 may extend in the circumferential direction of the insertion space. If power is applied to the wiring layer 184, a current may flow through the heat generating layer 182, and the heat generating layer 182 may generate heat.

The heat generating portion 180 may include a base layer 181 surrounding the insertion space. The heat generating layer 182 may be stacked on the base layer 181. The base layer 181 may be closest to the insertion space. The base layer 181 may form the innermost surface of the heat generating portion 180. The base layer 181 may protect the heat generating layer 182. For example, the base layer 181 may reduce damage to the heat generating layer 182 due to external force.

The heat generating portion 180 may include a protective layer 185 stacked on the wiring layer 184. The protective layer 185 may be spaced farthest from the insertion space. The protective layer 185 may form the outermost surface of the heat generating portion 180. The protective layer 185 may protect the wiring layer 184. For example, the protective layer 185 may reduce damage to the metal pattern of the wiring layer 184 due to external force. The wiring layer 184 and the heat generating layer 182 may be located between the base layer 181 and the protective layer 185.

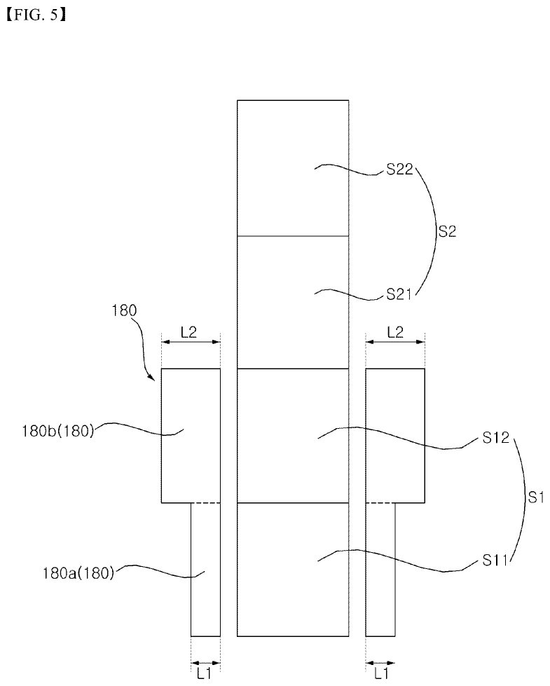

FIG. 5 is a cross-sectional view of the stick and the heater according to the embodiment of the present disclosure.

Referring to FIG. 5, the heat generating portion may include a first heat generating portion 180a configured to heat the first substance portion S11 and a second heat generating portion 180b configured to heat the second substance portion S12.

The first heat generating portion 180a may correspond to the first substance portion S11. For example, the position of the first heat generating portion 180a may correspond to the position of the first substance portion S11. For example, the extension length of the first heat generating portion 180a may correspond to the extension length of the first substance portion S11. The first heat generating portion 180a may surround a portion of the insertion space. The first heat generating portion 180a may surround the first substance portion S11. The first heat generating portion 180a may surround the inner portion of the insertion space.

The second heat generating portion 180b may correspond to the second substance portion S12. For example, the position of the second heat generating portion 180b may correspond to the position of the second substance portion S12. For example, the extension length of the second heat generating portion 180b may correspond to the extension length of the second substance portion S12. The second heat generating portion 180b may surround a portion of the insertion space. The second heat generating portion 180b may surround the second substance portion S12. The second heat generating portion 180b may surround an outer portion of the insertion space.

The thickness L of the heat generating portion 180 (refer to FIG. 3) may vary in the depth direction of the insertion space. For example, the thickness L of the heat generating portion 180 may gradually decrease in a direction approaching the deepest portion of the insertion space. On the contrary, the thickness L of the heat generating portion 180 may gradually increase in a direction approaching the shallowest portion of the insertion space. The thickness L2 of the second heat generating portion 180b may be greater than the thickness L1 of the first heat generating portion 180a. The thickness L1 of the first heat generating portion 180a may be less than the thickness L2 of the second heat generating portion 180b. The thickness L2 of the second heat generating portion 180b may gradually decrease in a direction approaching the first heat generating portion 180a. The thickness L2 of the second heat generating portion 180b may gradually decrease in a direction moving away from the center of the second heat generating portion 180b.

The first heat generating portion 180a and the second heat generating portion 180b may be connected to each other. The first heat generating portion 180a and the second heat generating portion 180b may be electrically connected to each other. The second heat generating portion 180b may extend from the first heat generating portion 180a. The first heat generating portion 180a and the second heat generating portion 180b may be integrally formed with each other. When power is applied, a current may flow through the first heat generating portion 180a and the second heat generating portion 180b. In this case, the first heat generating portion 180a and the second heat generating portion 180b may generate heat. The temperature of the heated second heat generating portion 180b may be higher than the temperature of the heated first heat generating portion 180a. Accordingly, the magnitude of thermal energy applied to the second substance portion S12 may be greater than the magnitude of thermal energy applied to the first substance portion S11. The amount of heat received by the second substance portion S12 may be greater than the amount of heat received by the first substance portion S11. Accordingly, when power is applied, the temperature of the second substance portion S12 may be higher than the temperature of the first substance portion S11. However, the disclosure is not limited thereto. The relationship between the heating temperature of the first substance portion S11 and the heating temperature of the second substance portion S12 may be reversed depending on the types of substances contained in the first substance portion S11 and the second substance portion S12.

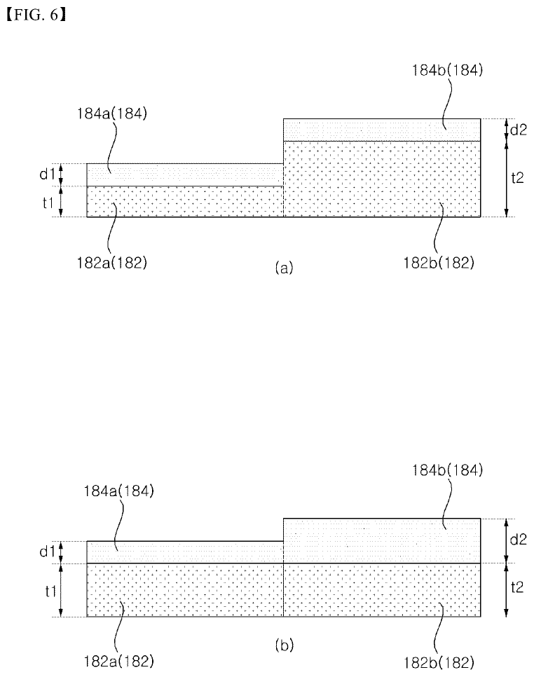

FIG. 6 is a cross-sectional view of the heat generating portion according to embodiments of the present disclosure.

Referring to FIG. 6, the thickness of the heat generating portion 180 may be determined by the thickness of the heat generating layer 182 and/or the thickness of the wiring layer 184.

The first heat generating portion 180a may include a first heat generating layer 182a and a first wiring layer 184a. The first heat generating layer 182a may be a part of the heat generating layer 182. For example, the first heat generating layer 182a may be a part of the heat generating portion 180 that corresponds to the first substance portion S11.

The first wiring layer 184a may be stacked on the first heat generating layer 182a. The first wiring layer 184a may be formed on the first heat generating layer 182a. Power may be applied to the first wiring layer 184a. When power is applied, a current may flow through the first wiring layer 184a. The first heat generating layer 182a may have electrical conductivity. A current may flow through the first heat generating layer 182a, and heat may be generated in the first heat generating layer 182a.

The second heat generating portion 180b may include a second heat generating layer 182b and a second wiring layer 184b. The second heat generating layer 182b may be a part of the heat generating layer 182. For example, the second heat generating layer 182b may be a part of the heat generating portion 180 that corresponds to the second substance portion S12. The second heat generating layer 182b may be integrally formed with the first heat generating layer 182a. The second heat generating layer 182b may be connected to the first heat generating layer 182a.

The second wiring layer 184b may be stacked on the second heat generating layer 182b. The second wiring layer 184b may be formed on the second heat generating layer 182b. Power may be applied to the second wiring layer 184b. When power is applied, a current may flow through the second wiring layer 184b. The second heat generating layer 182b may have electrical conductivity. A current may flow through the second heat generating layer 182b, and heat may be generated in the second heat generating layer 182b.

As the thickness t of the heat generating layer 182 increases, the amount of thermal energy generated in the heat generating layer 182 may increase. That is, as the thickness t of the heat generating layer 182 increases, the temperature of the heat generating layer 182 may increase. As the thickness t of the heat generating layer 182 increases, the amount of heat applied to the stick S may increase. As the thickness t of the heat generating layer 182 increases, the temperature of the stick S may increase.

Referring to FIG. 6(a), the thickness t2 of the second heat generating layer 182b may be greater than the thickness t1 of the first heat generating layer 182a. In this case, the thickness d2 of the second wiring layer 184b may correspond to the thickness d1 of the first wiring layer 184a. The thickness t2 of the second heat generating layer 182b may be constant. The thickness t1 of the first heat generating layer 182a may be constant. Because the thickness t2 of the second heat generating layer 182b is greater than the thickness t1 of the first heat generating layer 182a, the temperature of the second heat generating layer 182b may be higher than the temperature of the first heat generating layer 182a. Accordingly, the temperature of the heated second substance portion S12 may be higher than the temperature of the heated first substance portion S11. However, the disclosure is not limited thereto. The relationship between the thickness t2 of the second heat generating layer 182b and the thickness t1 of the first heat generating layer 182a may be reversed. In this case, the temperature of the first heat generating layer 182a may be higher than the temperature of the second heat generating layer 182b, and the temperature of the heated first substance portion S11 may be higher than the temperature of the heated second substance portion S12. That is, the thickness t of the heat generating layer 182 may be adjusted depending on the type of substance contained in the corresponding part of the stick S.

As the thickness d of the wiring layer 184 increases, the amount of thermal energy generated in the heat generating layer 182 may increase. That is, as the thickness d of the wiring layer 184 increases, the temperature of the heat generating layer 182 may increase. As the thickness d of the wiring layer 184 increases, the amount of heat applied to the stick S may increase. As the thickness d of the wiring layer 184 increases, the temperature of the stick S may increase. The thickness d of the wiring layer 184 may be the thickness of the metal pattern formed on the heat generating layer 182.

Referring to FIG. 6(b), the thickness d2 of the second wiring layer 184b may be greater than the thickness d1 of the first wiring layer 184a. In this case, the thickness t2 of the second heat generating layer 182b may correspond to the thickness t1 of the first heat generating layer 182a. The first wiring layer 184a and the second wiring layer 184b may be connected to each other. The first wiring layer 184a and the second wiring layer 184b may be physically connected to each other. The first wiring layer 184a and the second wiring layer 184b may be integrally formed with each other. The thickness d2 of the second wiring layer 184b may be constant. The thickness d1 of the first wiring layer 184a may be constant. Because the thickness d2 of the second wiring layer 184b is greater than the thickness d1 of the first wiring layer 184a, the temperature of the second heat generating layer 182b may be higher than the temperature of the first heat generating layer 182a. Accordingly, the temperature of the heated second substance portion S12 may be higher than the temperature of the heated first substance portion S11. However, the disclosure is not limited thereto. The relationship between the thickness d2 of the second wiring layer 184b and the thickness d1 of the first wiring layer 184a may be reversed. In this case, the temperature of the first heat generating layer 182a may be higher than the temperature of the second heat generating layer 182b, and the temperature of the heated first substance portion S11 may be higher than the temperature of the heated second substance portion S12. That is, the thickness d of the wiring layer 184 may be adjusted depending on the type of substance contained in the corresponding part of the stick S.

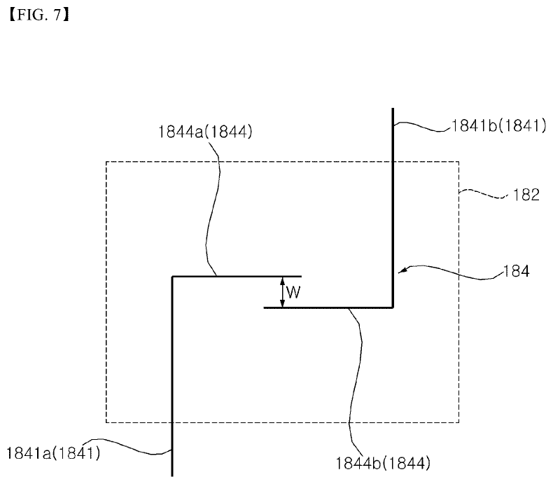

FIG. 7 is a view showing the wiring layer according to an embodiment of the present disclosure.

Referring to FIG. 7, the wiring layer 184 may include a power supply portion 1841 connected to the power supply 11 and a terminal portion 1844 extending from the power supply portion 1841.

The power supply portion 1841 may be connected to the power supply 11, and a current may flow through the wiring layer 184. The power supply portion 1841 may be connected to the power supply 11, and the wiring layer 184 may receive power. The power supply portion 1841 may include a pair of power supply portions 1841a and 1841b connected to the power supply 11. A potential difference of a predetermined voltage may be formed between the pair of power supply portions 1841a and 1841b. For example, the pair of power supply portions 1841a and 1841b may include a first power supply portion 1841a having a first potential and a second power supply portion 1841b having a second potential that is greater than the first potential by a predetermined voltage. A potential difference may be formed between the first power supply portion 1841a and the second power supply portion 1841b, and a current may flow through a pair of terminal portions 1844a and 1844b connected to the pair of power supply portions 1841a and 1841b.

The pair of power supply portions 1841a and 1841b may be spaced apart from each other. The pair of power supply portions 1841a and 1841b may extend in different directions. For example, the first power supply portion 1841a may extend to a first side of the heat generating layer 182, and the second power supply portion 1841b may extend to a second side of the heat generating layer 182. However, the disclosure is not limited thereto. The pair of power supply portions 1841a and 1841b may extend in one direction.

The wiring layer 184 may include a terminal portion extending from the power supply portion 1841. The terminal portion 1844 may extend from the power supply portion 1841 and may be bent. The pair of power supply portions 1841a and 1841b may include a pair of terminal portions 1844a and 1844b extending therefrom, respectively. The pair of terminal portions 1844a and 1844b may be spaced apart from each other. A current may flow between the pair of terminal portions 1844a and 1844b spaced apart from each other. A current may flow across an interval between the pair of terminal portions 1844a and 1844b spaced apart from each other through the heat generating layer 182. The heat generating layer 182 may be electrically conductive. For example, a potential difference may be formed between the first power supply portion 1841a and the second power supply portion 1841b, and the current flowing through the first terminal portion 1844a may flow to the second terminal portion 1844b through the heat generating layer 182. During this process, heat may be generated in the heat generating layer 182. The heat generating layer 182 may be thermally conductive. The heat generated in the heat generating layer 182 may heat the insertion space. The heat generated in the heat generating layer 182 may heat the stick S disposed in the insertion space, and the substances contained in the stick S may be aerosolized.

The first power supply portion 1841a may extend in a first direction, and the first terminal portion 1844a may be bent from one end of the first power supply portion and may extend in a second direction. The second power supply portion 1841b may extend in a direction opposite the first direction, and the second terminal portion 1844b may be bent from one end of the second power supply portion 1841b and may extend in a direction opposite the second direction. In this case, the first terminal portion 1844a and the second terminal portion 1844b may be spaced apart from each other by a predetermined distance W.

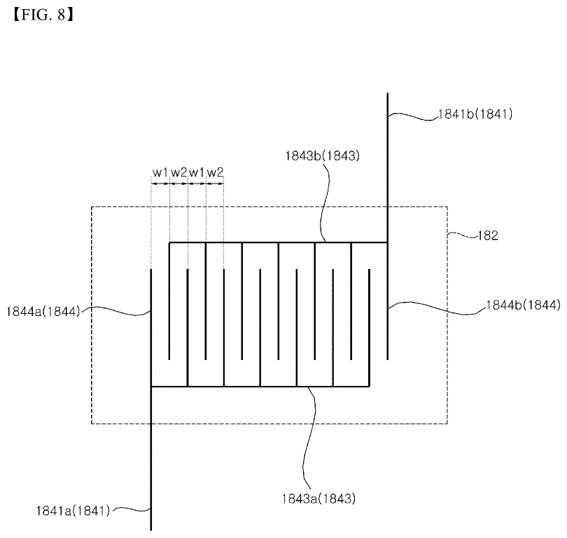

FIG. 8 is a view showing a wiring layer 184 according to another embodiment of the present disclosure.

Referring to FIG. 8, the terminal portion 1844 may include a main terminal 1843 extending from the power supply portion 1841 and a plurality of sub-terminals 1844 branching from the main terminal 1843.

The main terminal 1843 may extend from the power supply portion 1841. The main terminal 1843 may be directly connected to the power supply portion 1841. The main terminal 1843 may be bent from the power supply portion 1841. The terminal portion 1844 may include a pair of main terminals 1843a and 1843b extending from the pair of power supply portions 1841a and 1841b. For example, the terminal portion 1844 may include a first main terminal 1843a extending from the first power supply portion 1841a and a second main terminal 1843b extending from the second power supply portion 1841b. The first main terminal 1843a and the second main terminal 1843b may be spaced apart from each other. The first main terminal 1843a and the second main terminal 1843b may extend in different directions. For example, the first main terminal 1843a and the second main terminal 1843b may extend in opposite directions.

A plurality of sub-terminals 1844 may be provided. The plurality of sub-terminals 1844 may extend from the main terminal 1843. The sub-terminals 1844 may include a pair of a plurality of sub-terminals 1844 extending from the pair of main terminals 1843a and 1843b. For example, the sub-terminals 1844 may include a plurality of first sub-terminals 1844a extending from the first main terminal 1843a and a plurality of second sub-terminals 1844b extending from the second main terminal 1843b. The pair of the plural of sub-terminals 1844 may be alternately arranged. The pair of the plurality of sub-terminals 1844 may be spaced apart from each other. For example, the plurality of first sub-terminals 1844a and the plurality of second sub-terminals 1844b may be alternately arranged and spaced apart from each other. That is, the plurality of first sub-terminals 1844a may be respectively disposed between the plurality of second sub-terminals 1844b spaced apart from each other, and each of the first sub-terminals 1844a may be spaced apart from the second sub-terminal 1844b adjacent thereto. In this case, the first sub-terminals 1844a may be disposed on both sides of the second sub-terminal 1844b, one of the first sub-terminals 1844a may be spaced a first interval W1 from the second sub-terminal 1844b adjacent thereto, and the other of the first sub-terminals 1844a may be spaced a second interval W2 from the second sub-terminal 1844b adjacent thereto. The first interval W1 and the second interval W2 may be different from each other. The first interval W1 and the second interval W2 may correspond to each other.

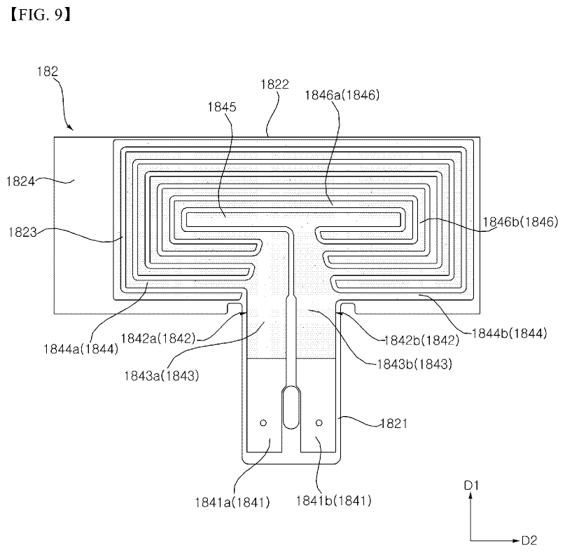

FIG. 9 is a view showing a heat generating portion according to another embodiment of the present disclosure.

Referring to FIG. 9, the heat generating portion 180 may include a heat generating layer 182 surrounding the insertion space and a wiring layer 184 stacked on the heat generating layer 182.

The heat generating layer 182 may include an extension portion 1821 on which the power supply portion 1841 is formed and a wiring portion 1822 on which the terminal portion 1844 is formed. The heat generating layer 182 may include an overlapping portion 1824 extending from the wiring portion 1822.

The overlapping portion 1824 may be a portion that overlaps the wiring portion when the heat generating layer 182 surrounds the insertion space. The overlapping portion 1824 may be adhered to the rear surface of the wiring portion 1822.

The power supply portion 1841 may be disposed on the extension portion 1821. The extension portion 1821 may extend from the wiring portion 1822. For example, the extension portion 1821 may extend from the wiring portion 1822 in a direction opposite the first direction D1. The extension portion 1821 may be disposed in the aerosol-generating device 1. The extension portion 1821 may be electrically connected to the power supply 11. Alternatively, the extension portion 1821 may be connected to an electric part.

The terminal portion 1844 may be disposed on the wiring portion 1822. A plurality of sub-terminals 1844 may be disposed on the wiring portion 1822. A main terminal 1843 may be disposed on the wiring portion 1822. The main terminal 1843 may be disposed on the extension portion 1821. For example, a first main terminal 1843a and a second main terminal 1843b may be disposed across the extension portion 1821 and the wiring portion 1822.

The power supply portion 1841 may be disposed on the extension portion 1821. The power supply portion 1841 may be connected to the electric part. The power supply portion 1841 may be connected to the power supply 11. A pair of power supply portions 1841a and 1841b may be disposed on one surface of the extension portion 1821 so as to be spaced apart from each other.

The main terminal 1843 may extend from the power supply portion 1841. For example, the first main terminal 1843a and the second main terminal 1843b may extend in the first direction D1 from the first power supply portion 1841a and the second power supply portion 1841b, respectively. The first main terminal 1843a and the second main terminal 1843b may extend so as to be connected to the plurality of sub-terminals 1844 disposed on the wiring portion 1822. The first main terminal 1843a and the second main terminal 1843b may extend to the central part of the wiring portion 1822. For example, the first main terminal 1843a and the second main terminal 1843b may extend in the first direction D1 from the first power supply portion 1841a and the second power supply portion 1841b located on the extension portion 1821, respectively, to the central part of the wiring portion 1822.

The sub-terminal 1844 may branch from the main terminal 1843. The plurality of sub-terminals 1844 may branch from the main terminal 1843 in one direction. A plurality of first sub-terminals 1844a may branch from the first main terminal 1843a. For example, the plurality of first sub-terminals 1844a may branch from the first main terminal 1843a in a direction opposite the second direction D2. Then, the plurality of first sub-terminals 1844a may extend in a direction opposite the second direction D2. Then, the plurality of first sub-terminals 1844a may be bent in the first direction D1. Then, the plurality of first sub-terminals 1844a may extend in the first direction D1. The first direction D1 may be the depth direction of the insertion space. That is, the first direction D1 may be a direction oriented from the deepest portion of the insertion space toward the shallowest portion of the insertion space. The second direction D2 may be the circumferential direction of the insertion space. The plurality of first sub-terminals 1844a extending in the first direction D1 may be bent and extend in the second direction D2. Then, the plurality of first sub-terminals 1844a may be bent and extend in a direction opposite the first direction D1. Then, the plurality of first sub-terminals 1844a may be bent and extend in a direction opposite the second direction D2.

A plurality of second sub-terminals 1844b may branch from the second main terminal 1843b. For example, the plurality of second sub-terminals 1844b may branch from the second main terminal 1843b in the second direction D2. Then, the plurality of second sub-terminals 1844b may extend in the second direction D2. Then, the plurality of second sub-terminals 1844b may be bent in the first direction D1. Then, the plurality of second sub-terminals 1844b may extend in the first direction D1. The plurality of second sub-terminals 1844b extending in the first direction D1 may be bent and extend in a direction opposite the second direction D2. Then, the plurality of second sub-terminals 1844b may be bent and extend in a direction opposite the first direction D1. Then, the plurality of second sub-terminals 1844b may be bent and extend in the second direction D2.

The plurality of first sub-terminals 1844a and the plurality of second sub-terminals 1844b may be alternately arranged. That is, the plurality of first sub-terminals 1844a branching from the first main terminal 1843a and extending in the peripheral direction of the wiring portion 1822 and the plurality of second sub-terminals 1844b branching from the second main terminal 1843b and extending in a direction opposite the peripheral direction of the wiring portion 1822 may be alternately arranged. In this case, the peripheral direction of the wiring portion 1882 may be a direction oriented in the clockwise direction along the periphery of the wiring portion 1822. Any one of the plurality of second sub-terminals 1844b may be surrounded by the plurality of first sub-terminals 1844a disposed thereabove and therebelow in the depth direction of the insertion space. That is, the first sub-terminals 1844a and the second sub-terminals 1844b may be alternately arranged in the depth direction of the insertion space.

The first sub-terminals 1844a and the second sub-terminals 1844b may be spaced apart from each other. For example, the first sub-terminals 1844a and the second sub-terminals 1844b may be spaced apart from each other in the first direction D1. The intervals between the first sub-terminals 1844a and the second sub-terminals 1844b may be constant. The wiring portion 1822 may include a gap portion 1823 located between the first sub-terminals 1844a and the second sub-terminals 1844b. A current may flow from the first sub-terminals 1844a to the second sub-terminals 1844b through the gap portion 1823. On the contrary, a current may flow from the second sub-terminals 1844b to the first sub-terminals 1844a through the gap portion 1823.

One of the first terminal portion 1844a and the second terminal portion 1844b may include a center terminal 1845. The center terminal 1845 may be disposed at the center part of the wiring portion 1822. The center terminal 1845 may extend from one end of any one of the first main terminal 1843a and the second main terminal 1843b. The center terminal 1845 may be connected to any one of the first main terminal 1843a and the second main terminal 1843b. For example, the center terminal 1845 may be connected to the other end of the second main terminal 1843b, and the second power supply portion 1841b may be connected to one end of the second main terminal 1843b.

The center terminal 1845 may extend in the circumferential direction of the insertion space. For example, the center terminal 1845 may extend in the second direction D2.

The center terminal 1845 may be surrounded by the shortest sub-terminal 1846 of any one of the first terminal portion 1844a and the second terminal portion 1844b. The shortest sub-terminal 1846 may be a sub-terminal having the shortest extension length among the plurality of sub-terminals 1844. The shortest sub-terminal 1846 may include a first shortest sub-terminal 1846a extending from the first terminal portion 1844a and a second shortest sub-terminal 1846b extending from the second terminal portion 1844b. The first shortest sub-terminal 1846a may extend from the other end of the first main terminal 1843a. For example, one end of the first main terminal 1843a may be connected to the first power supply portion 1841a, and the first shortest sub-terminal 1846a may extend from the other end of the first main terminal 1843a. The second shortest sub-terminal 1846b may extend from the other end of the second main terminal 1843b. For example, one end of the second main terminal 1843b may be connected to the second power supply portion 1841b, and the second shortest sub-terminal 1846b may extend from the other end of the second main terminal 1843b. For example, the center terminal 1845 may be connected to the other end of the second main terminal 1843b and may extend in the second direction D2, and the first shortest sub-terminal 1846a may surround the center terminal 1845.

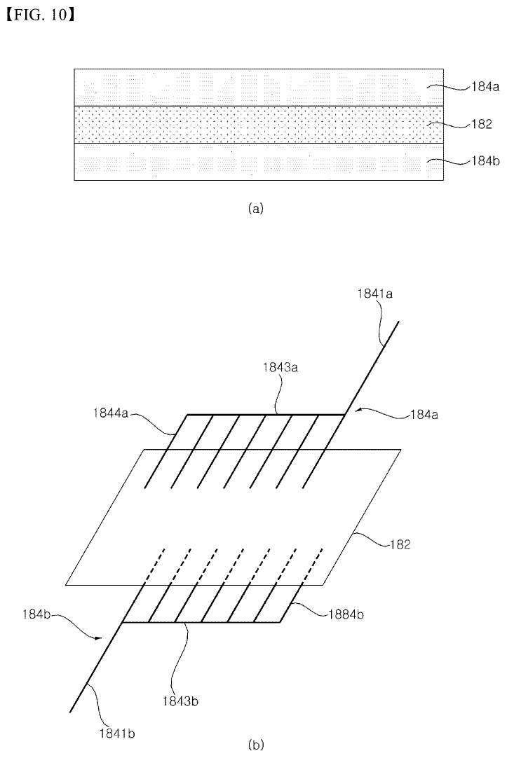

FIG. 10 is a view showing a heat generating portion 180 according to another embodiment of the present disclosure.

Referring to FIG. 10, a wiring layer 184 may include a first wiring layer 184a located on one surface of a heat generating layer 182 and a second wiring layer 184b located on the other surface of the heat generating layer 182.

The first wiring layer 184a may be located on one surface of the heat generating layer 182. For example, the first wiring layer 184a may be located on the surface of the heat generating layer 182. The surface of the heat generating layer 182 may be the outer surface of the heat generating layer 182. The first power supply portion 1841a and the first terminal portion 1844a may be located on the surface of the heat generating layer 182.

The second wiring layer 184b may be located on the other surface of the heat generating layer 182. The other surface of the heat generating layer 182 may be opposite the surface of the heat generating layer on which the first wiring layer 184a is located. For example, the second wiring layer 184b may be located on the back surface of the heat generating layer 182. The back surface of the heat generating layer 182 may be the inner surface of the heat generating layer 182. The second power supply portion 1841b and the second terminal portion 1844b may be located on the surface of the heat generating layer 182.

The power supply 11 may be connected to the first power supply portion 1841a located on one surface of the heat generating layer 182 and the second power supply portion 1841b located on the other surface of the heat generating layer 182. A potential difference may be formed between the first wiring layer 184a and the second wiring layer 184b. A current may flow from the first wiring layer 184a to the second wiring layer 184b through the heat generating layer 182. On the contrary, a current may flow from the second wiring layer 184b to the first wiring layer 184a through the heat generating layer 182. Heat may be generated in the heat generating layer 182 while a current flows therethrough.

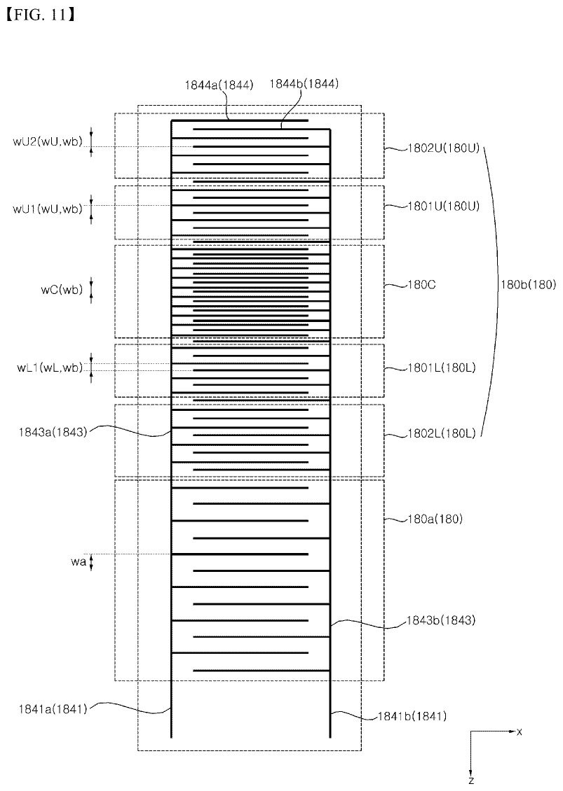

FIG. 11 is a schematic view showing a wiring layer that varies in structure in the depth direction of the insertion space according to another embodiment of the present disclosure. The z-axis direction may be the depth direction of the insertion space, and the x-axis direction may be the circumferential direction of the insertion space. The z-axis direction may be a direction oriented toward the deepest portion of the insertion space. The heat generating portion 180 may be bent in the x-axis direction, which is the circumferential direction of the insertion space, so as to surround the insertion space.

Referring to FIG. 11, a distance w between the sub-terminals 1844 may vary depending on the depth of the insertion space. The distance w between the sub-terminals 1844 may be an interval w between the first sub-terminal 1844a and the second sub-terminal 1844b alternately arranged adjacent to each other.

A distance wa between the sub-terminals 1844 of the first heat generating portion 180a may be longer than a distance wb between the sub-terminals 1844 of the second heat generating portion 180b. As the distance w between the sub-terminals 1844 increases, the magnitude of thermal energy generated may decrease. As the distance w between the sub-terminals 1844 increases, the temperature of the heat generating portion may decrease. The heating temperature of the first heat generating portion 180a may be lower than the heating temperature of the second heat generating portion 180b.

The second heat generating portion 180b may include a central heat generating portion 180C corresponding to the position of the central part of the second substance portion S12.

The second heat generating portion 180b may include a lower heat generating portion 180L located between the central heat generating portion 180C and the first heat generating portion 180a. The lower heat generating portion 180L may include a first lower heat generating portion 1801L and a second lower heat generating portion 1802L located at a deeper position than the first lower heat generating portion 1801L in the depth direction of the insertion space. The second lower heat generating portion 1802L may be located between the first lower heat generating portion 1801L and the first heat generating portion 180a. The first lower heat generating portion 1801L may be located between the central heat generating portion 180C and the second lower heat generating portion 1802L.

The second heat generating portion 180b may include an upper heat generating portion 180U located at a shallower position than the central heat generating portion 180C in the depth direction of the insertion space. The upper heat generating portion 180U may include a first upper heat generating portion 1801U and a second upper heat generating portion 1802U located at a shallower position than the first upper heat generating portion 1801U in the depth direction of the insertion space. The first upper heat generating portion 1801U may be located between the second upper heat generating portion 1802U and the central heat generating portion 180C.

A distance wC between the sub-terminals 1844 of the central heat generating portion 180C may be shortest in the heat generating portion. The distance wC between the sub-terminals 1844 of the central heat generating portion 180C may be shorter than a distance wU between the sub-terminals 1844 of the upper heat generating portion 180U or a distance wL between the sub-terminals of the lower heat generating portion 180L. Accordingly, the temperature of the second heat generating portion 180b may be highest near the central heat generating portion 180C. The temperature of the second heat generating portion 180b may gradually decrease from the central heat generating portion 180C to both ends of the second heat generating portion 180b in the depth direction of the insertion space.

A distance wL1 between the sub-terminals 1844 of the first lower heat generating portion 1801L may be longer than the distance wC between the sub-terminals 1844 of the central heat generating portion 180C. The distance wL1 between the sub-terminals 1844 of the first lower heat generating portion 1801L may be shorter than a distance wL2 between the sub-terminals 1844 of the second lower heat generating portion 1802L. Accordingly, the temperature of the first lower heat generating portion 1801L may be higher than the temperature of the second lower heat generating portion 1802L.

The temperature of the second lower heat generating portion 1802L may be lower than the temperature of the central heat generating portion 180C and the temperature of the first lower heat generating portion 1801L. The temperature of the second lower heat generating portion 1802L may be higher than that of the first heat generating portion 180a.

A distance wU1 between the sub-terminals 1844 of the first upper heat generating portion 1801U may be longer than the distance wC between the sub-terminals 1844 of the central heat generating portion 180C. The distance wU1 between the sub-terminals 1844 of the first upper heat generating portion 1801U may be shorter than a distance wU2 between the sub-terminals 1844 of the second upper heat generating portion 1802U. Accordingly, the temperature of the first upper heat generating portion 1801U may be higher than the temperature of the second upper heat generating portion 1802U.

The temperature of the second upper heat generating portion 1802U may be lower than the temperature of the central heat generating portion 180C and the temperature of the first upper heat generating portion 1801U. The temperature of the second upper heat generating portion 1802U may be higher than that of the first heat generating portion 180a.

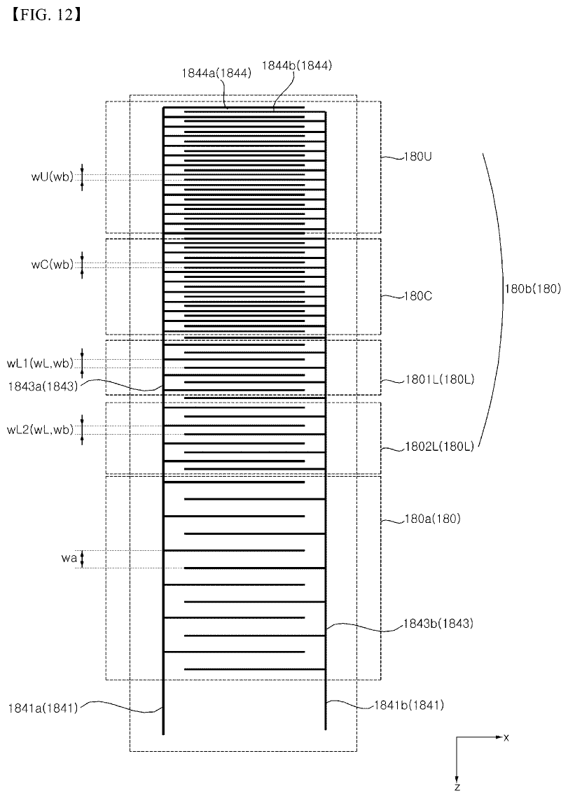

FIG. 12 is a schematic view showing a wiring layer that varies in structure in the depth direction of the insertion space according to another embodiment of the present disclosure.

Referring to FIG. 12, a distance w between the sub-terminals 1844 may gradually increase in a direction approaching the deepest portion of the insertion space.

A distance wU between the sub-terminals 1844 of the upper heat generating portion 180U may be shorter than a distance wL between the sub-terminals 1844 of the lower heat generating portion 180L. The distance wU between the sub-terminals 1844 of the upper heat generating portion 180U may correspond to or be shorter than a distance wC between the sub-terminals 1844 of the central heat generating portion 180C. Alternatively, the distance wU between the sub-terminals 1844 of the upper heat generating portion 180U may be longer than the distance wC between the sub-terminals 1844 of the central heat generating portion 180C.

The distance wL between the sub-terminals 1844 of the lower heat generating portion 180L may be longer than the distance wC between the sub-terminals 1844 of the central heat generating portion 180C and the distance wU between the sub-terminals 1844 of the upper heat generating portion 180U. Accordingly, the temperature of the upper heat generating portion 180U and the temperature of the central heat generating portion 180C may be higher than the temperature of the lower heat generating portion 180L.

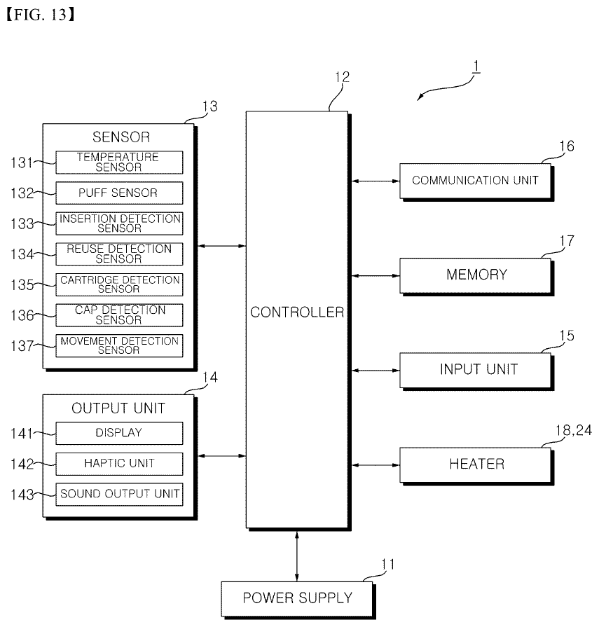

FIG. 13 is a block diagram of an aerosol-generating device 1 according to an embodiment of the present disclosure.

Referring to FIG. 13, the aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 13. That is, it is to be understood by those skilled in the art that some of the components shown in FIG. 13 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a cartridge detection sensor 135, a cap detection sensor 136, or a movement detection sensor 137.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The insertion detection sensor 133 may detect insertion and/or removal of the stick S. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor. The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S.

The reuse detection sensor 134 may detect whether the stick S is being reused. The reuse detection sensor 134 may be a color sensor. The color sensor may detect the color of the stick S. The color sensor may detect the color of a portion of the wrapper surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The cartridge detection sensor 135 may detect mounting and/or removal of the cartridge 19. The cartridge detection sensor 135 may be implemented as an inductance-based sensor, a capacitive sensor, a resistance sensor, a Hall sensor (or Hall IC) using the Hall effect, etc.

The cap detection sensor 136 may detect mounting and/or removal of the cap. When the cap is separated from the body 10, the cartridge 19 and the portion of the body 10 that have been covered by the cap may be exposed to the outside. The cap detection sensor 136 may be implemented as a contact sensor, a Hall sensor (or Hall IC), an optical sensor, etc.

The movement detection sensor 137 may detect movement of the aerosol-generating device. The movement detection sensor 137 may be implemented as at least one of an acceleration sensor or a gyro sensor.

In addition to the sensors 131 to 137 described above, the sensor 13 may further include at least one of a humidity sensor, a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touch screen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the cap, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery or a disposable battery. For example, the power supply 11 may be a lithium polymer (LiPoly) battery. However, the disclosure is not limited thereto.

Although not shown in FIG. 13, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although not shown in FIG. 13, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 13, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 13, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 13, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate the remaining amount of power stored in the power supply 11. For example, the controller 12 may calculate the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the cartridge 19 is coupled and/or removed using the cartridge detection sensor 135. For example, the controller 12 may determine whether the cartridge 19 is coupled and/or removed based on a sensing value of a signal from the cartridge detection sensor.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may determine whether use of the cartridge 19 is possible. For example, upon determining, based on the data stored in the memory 17, that the current number of puffs is equal to or greater than the maximum number of puffs set for the cartridge 19, the controller 12 may determine that use of the cartridge 19 is impossible. For example, when a total time period during which the cartridge heater 24 is heated is equal to or longer than a predetermined maximum time period or when the total amount of power supplied to the cartridge heater 24 is equal to or greater than a predetermined maximum amount of power, the controller 12 may determine that use of the cartridge 19 is impossible.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may determine whether the cap is coupled and/or removed using the cap detection sensor 136. For example, the controller 12 may determine, based on a sensing value of a signal from the cap detection sensor, whether the cap is coupled and/or removed.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the cap has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control such that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

Referring to FIGS. 1 to 13, an aerosol-generating device 1 in accordance with one aspect of the present disclosure may include a body including an insertion space to allow a stick to be inserted into the insertion space and a heater disposed in the body and including a heat generating portion configured to heat the insertion space. The heat generating portion may include a heat generating layer surrounding the insertion space and a wiring layer stacked on the heat generating layer and configured to supply a current, and the heat generating portion may have a thickness varying in the depth direction of the insertion space.

In addition, in accordance with another aspect of the present disclosure, the stick may include a first substance portion disposed in the insertion space and a second substance portion extending from the first substance portion and disposed in the insertion space, and the heat generating portion may include a first heat generating portion disposed at a position corresponding to the position of the first substance portion and a second heat generating portion disposed at a position corresponding to the position of the second substance portion and extending from the first heat generating portion. The second heat generating portion may have a thickness greater than the thickness of the first heat generating portion.

In addition, in accordance with another aspect of the present disclosure, a second heat generating layer of the second heat generating portion may have a thickness greater than the thickness of a first heat generating layer of the first heat generating portion.

In addition, in accordance with another aspect of the present disclosure, the thickness of the second heat generating layer may gradually decrease in a direction approaching the first heat generating portion.

In addition, in accordance with another aspect of the present disclosure, the thickness of the second heat generating layer may gradually decrease in a direction away from the center of the second heat generating layer.

In addition, in accordance with another aspect of the present disclosure, the first heat generating portion may include a first heat generating layer and a first wiring layer stacked on the first heat generating layer and configured to allow a current to flow therethrough, and the second heat generating portion may include a second heat generating layer and a second wiring layer stacked on the second heat generating layer and electrically connected to the first wiring layer. The second wiring layer may have a thickness greater than the thickness of the first wiring layer.

In addition, in accordance with another aspect of the present disclosure, the wiring layer may include a first wiring layer stacked on one surface of the heat generating layer and a second wiring layer stacked on the opposite surface of the heat generating layer.

In addition, in accordance with another aspect of the present disclosure, the heat generating portion may include a base layer configured to allow the heat generating layer to be stacked thereon and to form an inner surface of the heat generating portion and a protective layer configured to cover the wiring layer and to form an outer surface of the heat generating portion.

In addition, in accordance with another aspect of the present disclosure, the wiring layer may include a pair of power supply portions connected to a power supply and a pair of terminal portions respectively extending from the pair of power supply portions and spaced apart from each other, and the pair of terminal portions may be stacked on the heat generating layer and may surround the insertion space.

In addition, in accordance with another aspect of the present disclosure, the stick may include a first substance portion disposed in the insertion space and a second substance portion extending from the first substance portion and disposed in the insertion space, and the heat generating portion may include a first heat generating portion disposed at a position corresponding to the position of the first substance portion and including a first wiring layer and a second heat generating portion disposed at a position corresponding to the position of the second substance portion and including a second wiring layer. An interval between the pair of terminal portions located on the second wiring layer may be shorter than an interval between the pair of terminal portions located on the first wiring layer.

In addition, in accordance with another aspect of the present disclosure, the pair of power supply portions may include a first power supply portion and a second power supply portion spaced apart from the first power supply portion, and the pair of terminal portions may include a first terminal portion extending from the first power supply portion and a second terminal portion extending from the second power supply portion and spaced apart from the first terminal portion. The first terminal portion may include a first main terminal connected to the first power supply portion and a plurality of first sub-terminals branching from the first main terminal, and the second terminal portion may include a second main terminal connected to the second power supply portion and a plurality of second sub-terminals branching from the second main terminal.

In addition, in accordance with another aspect of the present disclosure, the plurality of first sub-terminals and the plurality of second sub-terminals may be alternately arranged and spaced apart from each other.

In addition, in accordance with another aspect of the present disclosure, the first main terminal may extend from the first power supply portion in a first direction. The plurality of first sub-terminals may extend in a second direction intersecting the first direction, may extend in the first direction, may extend in a direction opposite the second direction, may extend in a direction opposite the first direction, and then may extend in the second direction, and the plurality of second sub-terminals may extend in a direction opposite the second direction, may extend in the first direction, may extend in the second direction, may extend in a direction opposite the first direction, and then may extend in a direction opposite the second direction. The plurality of second sub-terminals may be located between the plurality of first sub-terminals.

In addition, in accordance with another aspect of the present disclosure, one of the first terminal portion and the second terminal portion may include a center terminal surrounded by a sub-terminal having the shortest extension length in the remaining one of the first terminal portion and the second terminal portion.

In addition, in accordance with another aspect of the present disclosure, the interval between the pair of terminal portions located on the second wiring layer may gradually increase in a direction approaching the first wiring layer.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a body comprising an insertion space to allow a stick to be inserted into the insertion space; and
a heater disposed in the body and comprising a heat generating portion configured to heat the insertion space,
wherein the heat generating portion comprises:
a heat generating layer surrounding the insertion space; and
a wiring layer stacked on the heat generating layer and configured to supply a current, and
wherein the heat generating portion has a thickness varying in a depth direction of the insertion space.

2. The aerosol-generating device according to claim 1, wherein the stick comprises:
a first substance portion disposed in the insertion space; and
a second substance portion extending from the first substance portion and disposed in the insertion space,
wherein the heat generating portion comprises:
a first heat generating portion disposed at a position corresponding to a position of the first substance portion; and
a second heat generating portion disposed at a position corresponding to a position of the second substance portion and extending from the first heat generating portion, and
wherein the second heat generating portion has a thickness greater than a thickness of the first heat generating portion.

3. The aerosol-generating device according to claim 2, wherein a second heat generating layer of the second heat generating portion has a thickness greater than a thickness of a first heat generating layer of the first heat generating portion.

4. The aerosol-generating device according to claim 3, wherein the thickness of the second heat generating layer gradually decreases in a direction approaching the first heat generating portion.

5. The aerosol-generating device according to claim 3, wherein the thickness of the second heat generating layer gradually decreases in a direction away from a center of the second heat generating layer.

6. The aerosol-generating device according to claim 2, wherein the first heat generating portion comprises:
a first heat generating layer; and
a first wiring layer stacked on the first heat generating layer and configured to allow a current to flow therethrough,
wherein the second heat generating portion comprises:
a second heat generating layer; and
a second wiring layer stacked on the second heat generating layer and electrically connected to the first wiring layer, and
wherein the second wiring layer has a thickness greater than a thickness of the first wiring layer.

7. The aerosol-generating device according to claim 1, wherein the wiring layer comprises:
a first wiring layer stacked on one surface of the heat generating layer; and
a second wiring layer stacked on an opposite surface of the heat generating layer.

8. The aerosol-generating device according to claim 1, wherein the wiring layer comprises:
a pair of power supply portions connected to a power supply; and
a pair of terminal portions respectively extending from the pair of power supply portions and spaced apart from each other, and
wherein the pair of terminal portions is stacked on the heat generating layer and surrounds the insertion space.

9. The aerosol-generating device according to claim 8, wherein the stick comprises:
a first substance portion disposed in the insertion space; and
a second substance portion extending from the first substance portion and disposed in the insertion space,
wherein the heat generating portion comprises:
a first heat generating portion disposed at a position corresponding to a position of the first substance portion and comprising a first wiring layer; and
a second heat generating portion disposed at a position corresponding to a position of the second substance portion and comprising a second wiring layer, and
wherein an interval between the pair of terminal portions located on the second wiring layer is shorter than an interval between the pair of terminal portions located on the first wiring layer.

10. The aerosol-generating device according to claim 8, wherein the pair of power supply portions comprises:
a first power supply portion; and
a second power supply portion spaced apart from the first power supply portion,
wherein the pair of terminal portions comprises:
a first terminal portion extending from the first power supply portion; and
a second terminal portion extending from the second power supply portion and spaced apart from the first terminal portion,
wherein the first terminal portion comprises:
a first main terminal connected to the first power supply portion; and
a plurality of first sub-terminals branching from the first main terminal, and
wherein the second terminal portion comprises:
a second main terminal connected to the second power supply portion; and
a plurality of second sub-terminals branching from the second main terminal.

11. The aerosol-generating device according to claim 10, wherein the plurality of first sub-terminals and the plurality of second sub-terminals are alternately arranged and spaced apart from each other.

12. The aerosol-generating device according to claim 10, wherein the first main terminal extends from the first power supply portion in a first direction,
wherein the plurality of first sub-terminals extends in a second direction intersecting the first direction, extends in the first direction, extends in a direction opposite the second direction, extends in a direction opposite the first direction, and then extends in the second direction,
wherein the plurality of second sub-terminals extends in a direction opposite the second direction, extends in the first direction, extends in the second direction, extends in a direction opposite the first direction, and then extends in a direction opposite the second direction, and
wherein the plurality of second sub-terminals is located between the plurality of first sub-terminals.

13. The aerosol-generating device according to claim 12, wherein one of the first terminal portion and the second terminal portion comprises a center terminal surrounded by a sub-terminal having a shortest extension length in a remaining one of the first terminal portion and the second terminal portion.

14. The aerosol-generating device according to claim 9, wherein the interval between the pair of terminal portions located on the second wiring layer gradually increases in a direction approaching the first wiring layer.

15. The aerosol-generating device according to claim 1, wherein the heat generating layer comprises at least one of graphene or carbon nanotubes, and
wherein the wiring layer is a metallic plate stacked on the heat generating layer.
